(19) United States
(12) Patent Application Publication
(10) Pub. No.: US 2016/0372084 A1
(43) Pub. Date: Dec. 22, 2016

(54) DRIVING CIRCUIT, DRIVING METHOD THEREOF AND DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventor: Jieqiong WANG, Beijing (CN)

(21) Appl. No.: 14/908,327

(22) PCT Filed: Sep. 16, 2015
(86) PCT No.: PCT/CN2015/089759

§ 371 Date: Jan. 28, 2016

(30) Foreign Application Priority Data
Jan. 26, 2015 (CN) 201510038539.0

(51) Int. Cl. G09G 5/18

(52) U.S. Cl. CPC G09G 5/18

(57) ABSTRACT

Embodiments of the present invention provide a driving circuit, a driving method thereof and a display device. The driving circuit includes a timing controller, a timing adjustor and a driver, wherein the timing controller outputs first data signal and first clock signal, the timing adjustor adjusts phases of first data signal and first clock signal, so as to generate second data signal and second clock signal corresponding to each other, and the driver generates driving signal based on second data signal and second clock signal. The timing adjustor actively adjusts first data signal and first clock signal output from the timing controller, so as to generate second data signal and second clock signal corresponding to each other and actually needed by the driver, thereby realizing a perfect match with a display panel, which in turn improves display quality of a display device.

### FIELD OF THE INVENTION

The present invention relates to the field of display technology, and particularly, to a driving circuit, a driving method thereof and a display device.

### BACKGROUND OF THE INVENTION

In a driving process of an existing display panel, a driver of the display panel receives a data signal and a clock signal output by a timing controller, and performs logic operations based on the data signal and the clock signal, thereby generating a driving signal used for driving the display panel. In this case, a phase difference between the data signal and the clock signal is a predetermined value, i.e., the data signal and the clock signal are corresponding to each other. However, in practical applications, the data signal and the clock signal will be subjected to different delays due to factors such as variety of sizes of display panels and circuit layouts, such that a data signal and a clock signal received by the driver cannot match with a data signal and a clock signal required by the driver, thereby affecting display quality of a display device.

### SUMMARY OF THE INVENTION

To solve the above problems, embodiments of the present invention provide a driving circuit, a driving method thereof and a display device, each of which is used for solving the problem that a data signal and a clock signal received by a driver cannot match with a data signal and a clock signal required by the driver, thereby affecting display quality of a display device.

An embodiment of the present invention provides a driving circuit including a timing controller, a timing adjustor and a driver, the timing adjustor being connected with an output of the timing controller and an output of the timing adjustor being connected with the driver. The timing controller is configured to output a first data signal and a first clock signal. The timing adjustor is configured to adjust phases of the first data signal and the first clock signal, so as to generate a second data signal and a second clock signal corresponding to each other. The driver is configured to generate a driving signal based on the second data signal and the second clock signal.

The timing adjustor may include a conversion unit and a synchronization unit, an input of the conversion unit being connected with the timing controller, a first output of the conversion unit being connected with a first input of the synchronization unit, a second output of the conversion unit being connected with the driver, a second input of the synchronization unit being connected with the timing controller, and an output of the synchronization unit being connected with the driver. The conversion unit is configured to adjust the phase of the first clock signal, so as to generate the second clock signal. The synchronization unit is configured to adjust the phase of the first data signal based on the second clock signal, so as to generate the second data signal, the second data signal and the second clock signal having a predetermined phase difference therebetween.

The conversion unit may include a plurality of delay circuits.

The delay circuit may include an inverter.

The inverter may be selected from a NMOS-type inverter, a PMOS-type inverter and a CMOS-type inverter.

The synchronization unit may include a D flip-flop.

The driver may include a source driver.

The driver and the timing adjustor may be provided integrally.

An embodiment of the present invention further provides a display device, including a display panel and any one of above driving circuits.

An embodiment of the present invention further provides a driving method for a driving circuit including a timing controller, a timing adjustor and a driver, the timing adjustor being connected with an output of the timing controller and an output of the timing adjustor being connected with the driver, and the method includes:

outputting a first data signal and a first clock signal by the timing controller;

adjusting phases of the first data signal and the first clock signal by the timing adjustor, so as to generate a second data signal and a second clock signal corresponding to each other; and

generating a driving signal by the driver based on the second data signal and the second clock signal.

The timing adjustor may include a conversion unit and a synchronization unit, an input of the conversion unit being connected with the timing controller, a first output of the conversion unit being connected with a first input of the synchronization unit, a second output of the conversion unit being connected with the driver, a second input of the synchronization unit being connected with the timing controller and an output of the synchronization unit being connected with the driver, wherein the step of adjusting phases of the first data signal and the first clock signal by the timing adjustor, so as to generate a second data signal and a second clock signal corresponding to each other includes:

adjusting the phase of the first clock signal by the conversion unit, so as to generate the second clock signal;

adjusting the phase of the first data signal by the synchronization unit based on the second clock signal, so as to generate the second data signal, the second data signal and the second clock signal having a predetermined phase difference therebetween.

The conversion unit may include a plurality of delay circuits.

The delay circuit may include an inverter.

The inverter may be selected from a NMOS-type inverter, a PMOS-type inverter and a CMOS-type inverter.

The synchronization unit may include a D flip-flop.

The driver may include a source driver.

The driver and the timing adjustor may be provided integrally.

The present invention has beneficial effects as below.

According to the driving circuit, the driving method thereof and the display device provided by embodiments of the present invention, the driving circuit includes a timing controller, a timing adjustor and a driver, wherein the timing controller outputs a first data signal and a first clock signal, the timing adjustor adjusts phases of the first data signal and the first clock signal, so as to generate a second data signal and a second clock signal corresponding to each other, and the driver generates a driving signal based on the second data signal and the second clock signal. The timing adjustor actively adjusts the first data signal and the first clock signal output from the timing controller, so as to generate the second data signal and the second clock signal corresponding to each other and actually needed by the driver, thereby realizing a perfect match with a display panel, which in turn improves display quality of a display device.

### BRIEF DESCRIPTION OF THE DRAWINGS

FIG. 1 is a block diagram schematically illustrating a driving circuit provided by Embodiment 1 of the present invention;

FIG. 2 is a block diagram schematically illustrating a timing adjustor shown in FIG. 1; and

FIG. 3 is a flow chart of a driving method for a driving circuit provided by Embodiment 3 of the present invention.

### DETAILED DESCRIPTION OF THE EMBODIMENTS

To make those skilled in the art better understand the technical solutions of the present invention, a driving circuit, a driving method thereof and a display device provided by embodiments of the present invention will be described below in details in conjunction with the accompanying drawings,

### Embodiment 1

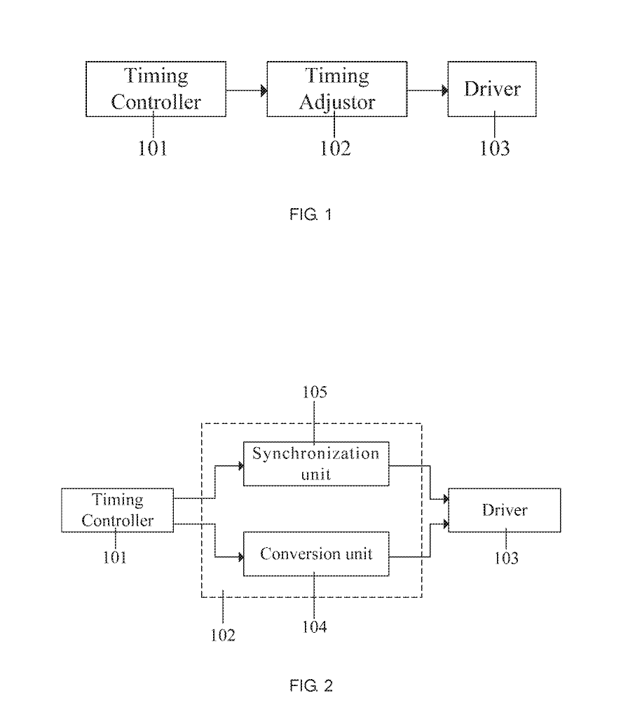

FIG. 1 is a block diagram schematically illustrating a driving circuit provided by Embodiment 1 of the present invention. As shown in FIG. 1, the driving circuit may include a timing controller 101, a timing adjustor 102 and a driver 103, wherein the timing adjustor 102 is connected with an output of the timing controller 101, and an output of the timing adjustor 102 is connected with the driver 103. The timing controller 101 is configured to output a first data signal and a first clock signal. The timing adjustor 102 is configured to adjust phases of the first data signal and the first clock signal, so as to generate a second data signal and a second clock signal corresponding to each other. The driver 103 is configured to generate a driving signal based on the second data signal and the second clock signal.

In the present embodiment, the timing controller 101 generates the first data signal and the first clock signal, and then transmits the first data signal and the first clock to the timing adjustor 102. In ideal cases, a phase difference between the first data signal and the first clock signal is a predetermined value. However, in practical applications, the first data signal and the first clock signal may be subjected to different delays due to factors such as circuit layouts, such that the phase difference between the first data signal and the first clock signal may be deviated from the predetermined value. In the present embodiment, the timing adjustor 102 adjusts the phases of the first data signal and the first clock signal after receiving the first data signal and the first clock signal, so as to generate a second data signal and a second clock signal with adjusted phases, the second data signal and the second clock signal being corresponding to each other. The driver 103 receives the second data signal and the second clock signal, and then generates a driving signal needed by a display panel based on the second data signal and the second clock signal, so as to realize a perfect match with the display panel, which in turn improves display quality of a display device.

FIG. 2 is a block diagram schematically illustrating the timing adjustor 102 shown in FIG. 1. As shown in FIG. 2, the timing adjustor 102 is connected with outputs of the timing controller 101, and outputs of the timing adjustor 102 are connected with the driver 103. The timing adjustor 102 may include a conversion unit 104 and a synchronization unit 105, wherein an input of the conversion unit 104 is connected with the timing controller 101; a first output of the conversion unit 104 is connected with a first input of the synchronization unit 105; a second output of the conversion unit 104 is connected with the driver 103; a second input of the synchronization unit 105 is connected with the timing controller 101; and an output of the synchronization unit 105 is connected with the driver 103.

The conversion unit 104 receives a first clock signal output by the timing controller 101, then adjusts a phase of the first clock signal to generate a second clock signal, and transmits the second clock signal to the synchronization unit 105 and the driver 103, respectively. The synchronization unit 105 receives a first data signal output by the timing controller 101 and the second clock signal output by the conversion unit 104, and then adjusts the phase of the first data signal based on a predetermined phase difference to generate a second data signal corresponding to the second clock signal.

The predetermined phase difference means the phase difference between a clock signal and a data signal that are actually needed by a driver of a display panel. In practical applications, one or more predetermined phase differences can be pre-stored in a storage unit (not shown in figures) based on parameters such as size of the display panel, and the predetermined phase difference can be set based on actual needs, so that the phase of the first data signal can be adjusted based on the predetermined phase difference upon receipt of the second clock signal by the synchronization unit, thereby generating the second data signal corresponding to the second clock signal and actually needed by the driver that drives the display panel.

In the present embodiment, the conversion unit 104 may include a plurality of delay circuits. The delay circuits provide different delays for the first clock signal, so as to adjust the phase of the first clock signal to generate the second clock signal.

In practical applications, any known delay circuit may be used to delay the phase of the first clock signal, and it is not limited herein. The delay circuit generally includes an inverter. Optionally, the inverter is a NMOS-type inverter or a PMOS-type inverter. As the NMOS-type inverter or the PMOS-type inverter requires only one type of transistor, the manufacturing cost of the driving circuit can be reduced. Preferably, the inverter is a CMOS-type inverter, The resistance of the CMOS-type inverter is relatively lower, so that power consumption of the circuit can be lowered. Furthermore, the CMOS-type inverter has an advantage of high processing efficiency, and it is more suitable for the driving circuit provided by the present invention.

Optionally, the synchronization unit 105 includes a D flip-flop. The D flip-flop includes a first input, a second input and an output, wherein the first input is used to receive the second clock signal, the second input is used to receive the first data signal, and the output is used to transmit the second data signal to the driver 103.

Optionally, the driver 103 includes a source driver. The source driver receives the second clock signal generated by the conversion unit 104 and the second data signal generated by the synchronization unit 105, and then generates a driving signal based on the second clock signal and the second data signal. As the second clock signal and the second data signal are corresponding to each other and are the clock signal and the data signal actually needed by the driver, a perfect match with a display panel can be realized, which in turn improves display quality of a display device.

Preferably, the timing adjustor 102 and the driver 103 are provided integrally, and as such, impacts on signals due to factors such as circuit layouts can be further reduced. In this case, it is more advantageous to obtain the data signal and the clock signal that are actually needed by the driver 103, and it is more advantageous to improve display quality of the display device.

According to the driving circuit provided by the present embodiment, the driving circuit includes a timing controller, a timing adjustor and a driver, wherein the timing controller outputs a first data signal and a first clock signal, the timing adjustor adjusts phases of the first data signal and the first clock signal, so as to generate a second data signal and a second clock signal corresponding to each other, and the driver generates a driving signal based on the second data signal and the second clock signal. The timing adjustor actively adjusts the first data signal and the first clock signal output from the timing controller, so as to generate the second data signal and the second clock signal corresponding to each other and actually needed by the driver, thereby realizing a perfect match with a display panel, which in turn improves display quality of a display device.

### Embodiment 2

The present embodiment provides a display device, which includes a display panel and the driving circuit provided by Embodiment 1, details of which may refer to the description in Embodiment 1 and will not be redundantly described herein.

According to the display device provided by the present embodiment, the driving circuit includes a timing controller, a timing adjustor and a driver, wherein the timing controller outputs a first data signal and a first clock signal, the timing adjustor adjusts phases of the first data signal and the first clock signal, so as to generate a second data signal and a second clock signal corresponding to each other, and the driver generates a driving signal based on the second data signal and the second clock signal. The timing adjustor actively adjusts the first data signal and the first clock signal output from the timing controller, so as to generate the second data signal and the second clock signal corresponding to each other and actually needed by the driver, thereby realizing a perfect match with the display panel, which in turn improves display quality of the display device.

### Embodiment 3

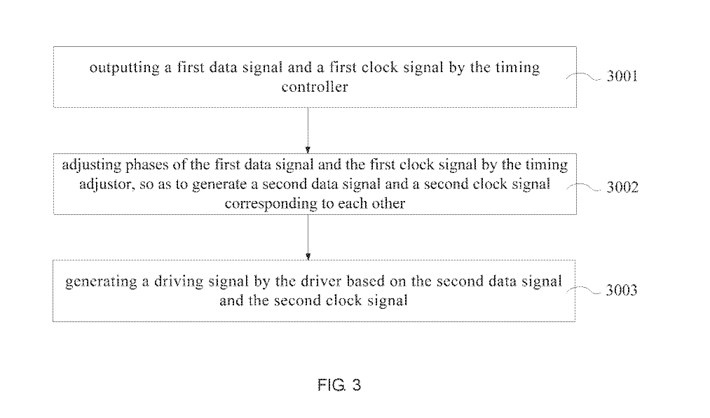

FIG. 3 is a flow chart of a driving method for a driving circuit provided by Embodiment 3 of the present invention. The driving circuit may includes a timing controller, a timing adjustor and a driver, wherein the timing adjustor is connected with an output of the timing controller, and an output of the timing adjustor is connected with the driver.

The driving method may include the following steps 3001 to 3003.

At step 3001, a first data signal and a first clock signal are output by the timing controller.

Specifically, in this step, the timing controller generates the first data signal and the first clock signal, and then transmits the first data signal and the first clock to the timing adjustor. In ideal cases, a phase difference between the first data signal and the first clock signal is a predetermined value, However, in practical applications, the first data signal and the first clock signal may be subjected to different delays due to factors such as circuit layouts, such that the phase difference between the first data signal and the first clock signal may be deviated from the predetermined value.

At step 3002, phases of the first data signal and the first clock signal are adjusted by the timing adjustor, so as to generate a second data signal and a second clock signal corresponding to each other.

Specifically, in this step, the timing adjustor adjusts the phases of the first data signal and the first clock signal after receiving the first data signal and the first clock signal, so as to generate the second data signal and the second clock signal with adjusted phases, the second data signal and the second clock signal being corresponding to each other.

More specifically, the timing adjustor may include a conversion unit and a synchronization unit, wherein an input of the conversion unit is connected with the timing controller; a first output of the conversion unit is connected with a first input of the synchronization unit; a second output of the conversion unit is connected with the driver; a second input of the synchronization unit is connected with the timing controller; and an output of the synchronization unit is connected with the driver.

The conversion unit receives the first clock signal output by the timing controller, then adjusts the phase of the first clock signal to generate the second clock signal, and transmits the second clock signal to the synchronization unit and the driver, respectively. The synchronization unit receives the first data signal output by the timing controller and the second clock signal output by the conversion unit, and then adjusts the phase of the first data signal based on a predetermined phase difference to generate the second data signal corresponding to the second clock signal.

In the present embodiment, the conversion unit may include a plurality of delay circuits. The delay circuits provide different delays for the first clock signal, so as to adjust the phase of the first clock signal to generate the second clock signal.

In practical applications, any known delay circuit may be used to delay the phase of the first clock signal, and it is not limited herein. The delay circuit generally includes an inverter. Optionally, the inverter is a NMOS-type inverter or a PMOS-type inverter. As the NMOS-type inverter or the PMOS-type inverter requires only one type of transistor, the manufacturing cost of the driving circuit can be reduced. Preferably, the inverter is a CMOS-type inverter. The resistance of the CMOS-type inverter is relatively lower, so that power consumption of the circuit can be lowered. Furthermore, the CMOS-type inverter has an advantage of high processing efficiency, and it is more suitable for the driving circuit provided by the present invention.

Optionally, the synchronization unit includes a D flip-flop. The D flip-flop includes a first input, a second input and an output, wherein the first input is used to receive the second clock signal, the second input is used to receive the first data signal, and the output is used to output the second data signal to the driver.

At step 3003, a driving signal is generated by the driver based on the second data signal and the second clock signal.

Specifically, in this step, the driver receives the second data signal and the second clock signal, and then generates the driving signal needed by the display panel based on the second data signal and the second clock signal, thereby realizing a perfect match with a display panel, which in turn improves display quality of a display device.

Optionally, the driver includes a source driver. The source driver receives the second clock signal generated by the conversion unit and the second data signal generated by the synchronization unit, and then generates the driving signal based on the second clock signal and the second data signal. As the second clock signal and the second data signal are corresponding to each other and are the clock signal and the data signal actually needed by the driver, a perfect match with the display panel can be realized, which in turn improves display quality of the display device.

Preferably, the timing adjustor and the driver are provided integrally, and as such, impacts on signals due to factors such as circuit layouts can be further reduced. In this case, it is more advantageous to obtain the data signal and the clock signal that are actually needed by the driver, and it is more advantageous to improve display quality of the display device.

According to the driving method for the driving circuit provided by the present embodiment, the driving circuit includes a timing controller, a timing adjustor and a driver, wherein the timing controller outputs a first data signal and a first clock signal, the timing adjustor adjusts phases of the first data signal and the first clock signal, so as to generate a second data signal and a second clock signal corresponding to each other, and the driver generates a driving signal based on the second data signal and the second clock signal. The timing adjustor actively adjusts the first data signal and the first clock signal output from the timing controller, so as to generate the second data signal and the second clock signal corresponding to each other and actually needed by the driver, thereby realizing a perfect match with the display panel, which in turn improves display quality of the display device.

It is to be understood that the foregoing implementations are merely exemplary embodiments for explaining the principle of the present invention, and the present invention is not limited thereto. Various modifications and improvements can be made by those skilled in the art without departing from the spirit and essence of the present invention, and these modifications and improvements shall also fall within the scope of the present invention.

1. A driving circuit, which includes a timing controller, a timing adjustor and a driver, the timing adjustor being connected with an output of the timing controller, and an output of the timing adjustor being connected with the driver, wherein
the timing controller is configured to output a first data signal and a first clock signal;
the timing adjustor is configured to adjust phases of the first data signal and the first clock signal, so as to generate a second data signal and a second clock signal corresponding to each other; and
the driver is configured to generate a driving signal based on the second data signal and the second clock signal.

2. The driving circuit according to claim 1, wherein the timing adjustor includes a conversion unit and a synchronization unit, an input of the conversion unit being connected with the timing controller, a first output of the conversion unit being connected with a first input of the synchronization unit, a second output of the conversion unit being connected with the driver, a second input of the synchronization unit being connected with the timing controller, and an output of the synchronization unit being connected with the driver; and wherein
the conversion unit is configured to adjust the phase of the first clock signal, so as to generate the second clock signal; and
the synchronization unit is configured to adjust the phase of the first data signal based on the second clock signal, so as to generate the second data signal, the second data signal and the second clock signal having a predetermined phase difference therebetween.

3. The driving circuit according to claim 2, wherein the conversion unit includes a plurality of delay circuits.

4. The driving circuit according to claim 3, wherein the delay circuit includes an inverter.

5. The driving circuit according to claim 4, wherein the inverter is selected from a NMOS-type inverter, a PMOS-type inverter and a CMOS-type inverter.

6. The driving circuit according to claim 2, wherein the synchronization unit includes a D flip-flop.

7. The driving circuit according to claim 1, wherein the driver includes a source driver.

8. The driving circuit according to claim 1, wherein the driver and the timing adjustor are provided integrally.

9. A display device, which includes a display panel and the driving circuit according to claim 1.

10. A driving method for a driving circuit including a timing controller, a timing adjustor and a driver, the timing adjustor being connected with an output of the timing controller, and an output of the timing adjustor being connected with the driver, the driving method including:
outputting a first data signal and a first clock signal by the timing controller;
adjusting phases of the first data signal and the first clock signal by the timing adjustor, so as to generate a second data signal and a second clock signal corresponding to each other; and
generating a driving signal by the driver based on the second data signal and the second clock signal.

11. The driving method for the driving circuit according to claim 10, wherein the timing adjustor includes a conversion unit and a synchronization unit, an input of the conversion unit being connected with the timing controller, a first output of the conversion unit being connected with a first input of the synchronization unit, a second output of the conversion unit being connected with the driver, a second input of the synchronization unit being connected with the timing controller, and an output of the synchronization unit being connected with the driver; and wherein
the step of adjusting phases of the first data signal and the first clock signal by the timing adjustor, so as to generate a second data signal and a second clock signal corresponding to each other includes:
adjusting the phase of the first clock signal by the conversion unit, so as to generate the second clock signal;
adjusting the phase of the first data signal by the synchronization unit based on the second clock signal, so as to generate the second data signal, the second data signal and the second clock signal having a predetermined phase difference therebetween.

12. The driving method for the driving circuit according to claim 11, wherein the conversion unit includes a plurality of delay circuits.

13. The driving method for the driving circuit according to claim 12, wherein the delay circuit includes an inverter.

14. The driving method for the driving circuit according to claim 13, wherein the inverter is selected from a NMOS-type inverter, a PMOS-type inverter and a CMOS-type inverter.

15. The driving method for the driving circuit according to claim 11, wherein the synchronization unit includes a D flip-flop.

16. The driving method for the driving circuit according to claim 10, wherein the driver includes a source driver.

17. The driving method for the driving circuit according to claim 10, wherein the driver and the timing adjustor are provided integrally.
